(19) United States
(12) Patent Application Publication
(10) Pub. No.: US 2015/0352759 A1
(43) Pub. Date: Dec. 10, 2015

(54) METHOD FOR PRODUCING A FOAM PRODUCT, AND DEVICE THEREFOR

(71) Applicant: Frank VAN LÜCK, Kaarst (DE)

(72) Inventor: Frank VAN LUCK, Kaarst (DE)

(21) Appl. No.: 14/763,593

(22) PCT Filed: Jan. 17, 2014
(86) PCT No.: PCT/EP2014/000126

§ 371 Date: Jul. 27, 2015

(30) Foreign Application Priority Data
Jan. 28, 2013 (DE) 10 2013 001 410.7

(51) Int. Cl. B29C 44/34

(52) U.S. Cl. CPC B29C 44/3415

(57) ABSTRACT

The invention relates to a method for producing an extruded foam product. An extrudate mixed with at least one blowing agent is guided through an extrusion tool (100). After the extrudate exits the extrusion tool, the extrudate is foamed by the blowing agent in order to create a foamed mass (110). Surface, edge-layer, or complete hardening of the foamed mass (110) exiting the extrusion tool within a temperature-control zone (106) adjacent to the extrusion tool is prevented by the temperature control of the foamed mass (110) within the temperature-control zone. The invention further relates to a device for performing said method.

### FIELD OF THE INVENTION

The present invention relates to the field of extrusion technology and in particular to the field of foam extrusion.

### PRIOR ART

It is known to use an extruder to produce foam products in which a plastic mass is fused. The fused plastic inside the extruder, which is also called extrudate, is mixed with blowing agent inside the extruder at high pressure and pressed through a shaping opening of the extruder. The shaping opening is provided by an extrusion tool which is located in that end of the extruder to which the extruder conveys the extrudate. After leaving the extrusion tool, the blowing agent decompresses and a foamed mass is formed which solidifies as a result of the foamed mass being conveyed from the extrusion tool into a space whose temperature is significantly below the melting point of the plastic, for example, at room temperature. As a result of the cooling, the cell growth is ended, where in particular during the production of closed-pore products the ending of the cell growth by cooling prevents the cells from bursting. The solidified mass is finished and the foam product is obtained.

The document DE 20117403 U1 describes a cooling mandrel which cools a foamed mass after exiting from an extrusion tool in order to produce a foamed product. For numerous applications, possibly for foam products for sound and heat insulation, it is however desirable to have a foam product available which has a lower density than can be achieved with conventional methods. It is therefore an object of the invention to indicate a possibility whereby a foam product having a lower density can be produced.

### DISCLOSURE OF THE INVENTION

This object is solved by the subject matters of the independent claims. Further advantages are obtained with the features of the dependent claims.

It has been identified that direct cooling after exit from the extrusion tool does not optimally configure cell growth and that in particular a lower density can be achieved if the mass is held in a not completely solidified state in order to homogenize the cell size in the cross-section of a foamed mass exiting from the extrusion tool. It was further identified that a subsequent expansion of an already-solidified mass certainly leads to a reduction in the density where however a specified delay of the solidification directly after exit from the extrusion tool leads to lower densities. Since the cell structure of the product can be specifically influenced, the desired foam product properties are maintained despite the lower density.

A method for producing an extruded foam product is therefore described, where an extrudate mixed with at least one blowing agent is guided through an extrusion tool. After exit from the extrusion tool, the extrudate is foamed by the blowing agent to form a foamed mass. A solidification of the foamed mass exiting from the extrusion tool within a temperature-control zone is prevented by temperature control of the foamed mass inside the temperature-control zone. The temperature-control zone here adjoins the extrusion tool. In particular, a surface, edge-layer or complete solidification is prevented. As a result, compensating processes between the cells of the foamed mass can take place inside the temperature-control zone so that cell sizes can compensate one another and a homogeneous cell structure is obtained, in particular a matching of the cell structure of cells located in the vicinity of the outer surface with respect to cells of the foamed mass located further inwards. The edge layer is the outermost layer of the foamed mass and has a higher density than regions located further inwards. The edge layer comprises or is defined by the outermost layer in which the density of the foamed mass is a factor of at least 20%, 40%, 60%, 80%, 100%, 125%, 150%, 175%, 200%, 300% and preferably at least 25%, 50%, 75%, 100% higher than the density in regions of the foamed mass located further inwards. Furthermore, the edge layer can be defined by means of its thickness with which it projects from the outer surface into regions of the foamed mass located further inwards. The edge layer preferably has a thickness of at least 0.2, 0.4, 0.6, 0.8, 1.0, 1.2, 1.4, 1.6, 1.8, 2.0, 2.2, 2.4, 2.6, 2.8, 3.0, 3.5, 4, 4.5, 5, 6, 7, 8, 9 or 10 millimetres and preferably of at least 0.2, 0.5, 1, 2, 5 or 10 millimetres. The edge layer can furthermore have a thickness of no more than 30, 20 or 15 millimetres. Depending on the production method, application, blowing agent, blowing agent pressure and type of plastic, this thickness can vary. In particular, during the production of insulating boards which are produced from foamed plastic, the thickness is usually at least 2 mm. In addition, the edge layer can be defined in terms of its relative thickness relative to the thickness of the foamed mass. The thickness of the edge layer is preferably at least 1%, 2%, 3%, 4%, 5%, 10%, 15%, 20% or 25% and preferably at least 2%, 5% or 10% of the thickness of the foamed material. The edge layer can furthermore have a thickness of no more than 50% or 40% of the thickness of the foamed material. As mentioned, this thickness can vary depending on the production method, application, blowing agent, blowing agent pressure and type of plastic. In particular, during the production of insulating boards which are produced from foamed plastic, the thickness is usually at least 5% and no more than 20% of the thickness of the foamed material. The thickness of the foamed material corresponds in particular to the distance between two opposite outer surfaces.

It is provided that an extrudate which comprises at least a plastic is fused and mixed with at least one blowing agent. This can take place in particular in a hollow cylinder of an extruder, where depending on blowing agent, this can also be added to the extrudate before introduction into the extruder. The extrudate together with the blowing agent is fused in the extruder. The resulting mixture is further conveyed in the extruder. For this purpose the extruder can have one, two or more than two conveying devices, in particular conveying screws. The conveying device produces a conveying direction which guides the extrudate together with the blowing agent to the extrusion tool and presses it through this. After passage through the extrusion tool, the blowing agent decompresses since the pressure upstream of the extrusion tool is higher than that downstream of the extrusion tool. This definition relates to the conveying direction. In particular, after passage through the extrusion tool, the blowing agent can partially or completely have a phase transition, for example, from the liquid phase to the gaseous phase. As a result of the decompression, and in particular due to the phase transition, heat is removed from the extrudate which emerges from the extrusion tool as the already-mentioned foamed mass. The procedure described here can at least partially compensate for the associated cooling, where the temperature control in particular prevents a solidification of the surface or edge layer of the foamed mass and also a solidification of regions of the foamed mass located further inwards due to the expansion and/or due to the phase transition of the blowing agent. In this case, the surface designated here corresponds in particular to the outer surface as is herein defined. The edge layer is the outer layer of the foamed mass which comprises the outer surface and accounts for a fraction of the overall thickness of the foamed mass, for example as is defined further above. An edge-layer solidification is a solidification only of the edge layer. Depending on the temperature of the extrudate inside the extruder, on the solidification temperature or the solidification temperature range and on the amount of heat which is withdrawn due to the expansion or due to the phase transition of the foamed mass, heat can be supplied to or removed from the foamed mass in the temperature-control zone, where the amount of heat removed or supplied provides the foamed mass with a temperature in which this is preferably not completely liquid (in order to prevent bursting) and not completely solidified. In the temperature-control zone, the foamed mass is held at a temperature (or on a temperature profile along the conveying direction or on a temperature interval) which keeps the foamed mass between a completely liquid and a completely solidified state. The foamed mass is held in a state in which it can be deformed plastically by the blowing agent within the temperature-control zone. The foamed mass is further held within the temperature-control zone in a not completely liquid state in which the pressure of the blowing agent is not sufficient to cause the cells produced by the foaming to explode.

In the temperature-control zone, the foamed mass is provided with a temperature profile over the cross-section of the foamed mass which in particular provides temperatures on the outer surface of the foamed mass at which the mass certainly remains plastically deformable but prevents bursting of the cells of the foamed mass on the outer surface. The temperature profile provides temperatures for the inner zones of the mass which enables a deformation of the cells and in particular enables a displacement of wall between adjacent cells. These temperatures are dependent on the plastic properties of the foamed mass and, for example, also on the residence time of the mass inside the temperature-control zone and can readily be determined by controlling the heat supply or heat removal within the temperature-control zone. Within the temperature-control zone, the foamed mass can be temperature-controlled to a temperature (or to a temperature profile) which lies no more than 20 K, 10 K, 5 K or 1 K above the melting point or the upper melting point of the mass. Furthermore, within the temperature-control zone, the foamed mass can be temperature-controlled to a temperature (or to a temperature profile) which lies no more than 20 K, 10 K, 5 K or 1 K below the melting point or the lower melting point of the foamed mass. In particular, in the case of plastic mixtures as extrudate, the foamed mass can have a melting range which extends from the lower to the upper melting point. The temperature to which the foamed mass is temperature-controlled can also lie between the lower and the upper melting point, preferably no more than 10 K, 5 K or 1 K above the lower melting point.

The temperature-control zone within which the temperature control takes place can directly adjoin the extrusion tool. Furthermore, the temperature-control zone can adjoin the extrusion tool via an intermediate section, where the foamed mass is preferably provided within the intermediate section with a temperature above a minimum temperature. The minimum temperature preferably lies above a temperature at which surface, edge-layer or complete solidification of the foamed mass takes place but can, for example, also lie 5 K, 10 K, 20 K or 30 K below this temperature. This can in particular only apply to the outer surface of the foamed mass where inner zones of the foamed mass, as a result of a lack of cooling effects on the outer surface, can have a higher temperature than the outer surface of the foamed mass. The residence time and temperature or temperature distribution within the intermediate section depends in particular on the density of the foamed mass, on the thermal capacity of the foamed mass and on expansion processes within the foamed mass which in turn depend on the concentration or the pressure of the blowing agent. The temperature and the residence time of the intermediate section are selected in such a manner that in the directly following temperature-control zone, the foamed mass can be transferred into an at least partially plastically deformable state as described above. After leaving the temperature-control zone or at the end thereof, the foamed mass is completely solidified and becomes a foam body. The foam body itself corresponds to the foam product to be produced or corresponds in cut form to the foam product to be produced or corresponds to a preform of the foam product to be produced which is obtained by further process steps from the foam body.

In one embodiment of the method, a duration and/or a temperature profile of the temperature control provides a pressure compensation between closed cells of different cross-sectional position in the foamed mass by plastic variation of the cells. In other words, the duration and/or the temperature profile (in the conveying direction) is provided in such a manner that zones located further inwards in the foamed mass have cells which can expand due to the blowing agent within the temperature-control zone and that as a result of the expansion of zones located further inwards, cells in zones located further outwards can be displaced outwards or cell walls can migrate outwards. Outwards means here a direction directed towards the outer surface, in particular a radial direction of the foamed mass. Further inwards and further outwards are positional designations which merely relate to a relative position of zones of the foamed mass. The temperature control assists a compensation of the cell sizes of cells having different radial position within the foamed mass.

This compensation is extended temporally by the method according to the invention compared with a non-temperature-control method, with the result that a homogenization of the density is obtained within the cross-section of the foamed mass.

A further embodiment provides that a duration and/or a temperature profile of the temperature control and/or a pressure provided by the blowing agent prevents bursting of cells at an outer surface of the foamed mass. In particular, a temperature-control arrangement which provides the temperature-control zone is designed with regard to the temperature-control in such a manner that within the temperature-control zone, cells on the outer surface do not burst. Furthermore the temperature-control arrangement can be actuated in such a manner that within the temperature-control zone, cells at the outer surface do not burst. Furthermore a controller can be provided which actuates the temperature-control arrangement so that within the temperature-control zone, cells at the outer surface do not burst. The temperature-control arrangement and/or the controller can be adapted to the blowing agent, to the material of the extrudate and/or to the conveying speed of the foamed mass and can be adjusted depending on this in order to prevent any bursting of these cells. Bursting of cells at the outer surface is preferably designated as the bursting of more than 1/10000, 1/1000, 1/100, 1/50, 1/20, 1/10 or ⅕ of all the cells which have at least one side wall which is part of the outer surface of the foamed mass.

Further embodiments provide that during the temperature control of the foamed mass, heat is supplied or removed from this. In addition, heat can be supplied at a first point of the temperature-control zone and heat can be removed at a second cell which differs from this. Heat can be supplied or removed by physical contact between the foamed mass and a surface along which the foamed mass is passed. Heat transfer is obtained by direct physical contact and in particular by transfer of thermal radiation between the foamed mass and the surface. Furthermore, heat can be supplied or removed by guiding a temperature-control flow along the foamed mass. The temperature-control flow comprises a temperature-control fluid, preferably gas or also a liquid. The temperature-control fluid is preferably heated or cooled by guiding along the mass. The flow can be produced by means of a pump. The flow can be guided by a flow-guiding element, possibly by means of a baffle plate or by means of a diffuser. In addition, heat can be supplied by irradiating with thermal radiation or microwave radiation. In this case, a heating element inside the temperature-control zone can be directed onto the foamed mass. Alternatively or in combination with this, a microwave emitter can be directed onto the mass.

When using an extrusion tool having an opening cross-section which circumferentially encloses an unopened inner region or which has an incision, possibly in the case of a round-slot nozzle or a nozzle having a U-shaped gap, a foamed mass is obtained which has a non-outwardly directed (part) surface. In addition to the outwardly directed surface of the foamed mass, this surface is also designated as outer surface and can be temperature-controlled as described here by supplying heat or removing heat. The physical contact, the temperature-control flow or the irradiation can also take place on an inner side of the foamed mass. The surface which forms an interface of the mass to the atmosphere is designated as outer surface. If the foamed mass encloses a region which is not filled with foamed mass, the interface between mass and region forms a part of the outer surface. The inner surface relates to the surface of the cell walls of cells inside the foamed mass and in particular all the surfaces contained in the foamed mass. The outer surface corresponds in particular to the remaining surface. In the case of such foamed masses having a hollow cross-section as described hereinbefore, heat removal elements or heat supply elements of the temperature-control arrangement or the temperature-control arrangement can be provided inside the region which is not filled with the foamed mass. In particular, a flow guiding element or a heat-removing or heat-supplying surface to be contacted or also a heating element or a microwave emitter can be provided in this region. The foamed mass is guided past these components (outside).

A further embodiment relates to the application of pressure to the foamed mass or to its outer surface. Contact pressure is applied to the foamed mass which counteracts the pressure of the blowing agent. It has been described previously that by means of appropriate temperature-control, a homogenization of the density over the cross-section is made possible. Furthermore, it is explained here that this temperature control—in particular the residence time in the temperature-control zone and/or the temperature or the temperature profile—is also used to prevent bursting of cells on the outer surface. Another possibility is indicated hereinafter whereby a bursting at the foamed mass at the outer surface can be prevented.

In one such embodiment of the method, within the temperature-control zone a contact pressure is applied to an outer surface of the foamed mass. The foamed mass is guided along a surface which applies the contact pressure to the outer surface of the foamed mass. As a result of the guidance, the foamed surface is guided whilst applying a force in a certain manner so that the surface along which the mass is guided can apply the contact pressure. The surface is formed by a solid. The surface is not deformed by the guiding and in this sense rigid. Alternatively or in combination with this, a contact pressure can be applied by a liquid or a gas, which is configured as a flow. A fluid flow is directed onto the outer surface of the foamed mass.

This applies the contact pressure. For the said possibilities of applying a contact pressure, it applies in particular that the contact pressure is at least as high as a foaming pressure which is produced by the blowing agent inside the foamed mass in order to locally delimit the cross-section of the foamed mass. Alternatively the contact pressure can be lower than the foaming pressure in order to increase the cross-section of the foamed mass whilst the contact pressure is applied. In one further alternative, the contact pressure of the said possibilities is at least as high as a minimal pressure which is sufficient to press the foamed mass seamlessly onto another surface, possibly a surface which serves as a counter-bearing and/or for removing and/or supplying heat.

A particularly preferred embodiment of the method provides that the same means which applies the contact pressure is also used for temperature control and in particular for the removal or supply of heat. As described, for example, a surface at which the foamed mass is passed by (in particular in combination with another surface as counter-bearing or as clamping element) and/or a fluid flow can be used as means for applying the contact pressure. It can therefore be provided that the surface and/or the fluid flow which applies the contact pressure to the outer surface of the foamed mass, supplies heat to the foamed mass or removes heat from it or generally controls temperature. The temperature-control or the supply or removal can be accomplished by physical contact and/or by thermal radiation. Further elements can be provided which remove or supply heat but apply no pressure and further elements can be provided which apply pressure but do not remove or supply heat. The surface which applies a contact pressure can at least partially overlap with the surface via which heat is supplied or removed. Thus, a surface section can possibly be provided which radiates heat to the foamed mass but which as a result of the guidance of the foamed mass, is at a distance from this or at least applies no pressure and which goes over into a section which is used both for temperature control and for applying the contact pressure.

According to a further aspect, it can be provided that the extrusion tool through which the extrudate is guided, comprises a round-slot nozzle. The round-slot nozzle is provided with a circumferentially closed slot. The extrusion tool through which the extrudate is guided can comprise a wide-slot nozzle through which the extrudate is guided or a profiled nozzle. The round-slot nozzle forms the foamed mass as an annular foam body. A wide-slot nozzle forms the foamed mass as a flat foam body. A profile nozzle forms to desired dimensions and in particular defines the proportions of the cross-section. According to another approach, the round-slot nozzle is used in order to produce a hollow foam body or a foamed mass as a hollow mass. Furthermore, the wide-slot nozzle is used to produce a foam body having a solid cross-section. In the case of a hollow cross-section, heat can be supplied to the foamed mass from inside the hollow mass (i.e. from the free region in the cross-section of the hollow mass) or removed from this and/or a contact pressure can be applied from there (or also a counter-pressure by means of a counter-bearing inside this free region.

Furthermore, a device for producing an extruded foam product is described. The device comprises an extruder with an extrusion tool. The extruder and the extrusion tool preferably correspond to the extruders or extrusion tools described here. The device further comprises a temperature-control arrangement with at least one temperature-control zone, which adjoins the extrusion tool. The temperature-control zone preferably corresponds to the temperature-control zone described here. The temperature-control arrangement is adapted to provide the temperature-control zone as described here. The temperature-control arrangement has at least one heat supply and/or heat removal element. The heat supply and/or heat removal element is provided in the temperature-control zone or is coupled to said temperature-control zone in a heat-transmitting manner. The at least one heat supply and/or heat removal element is adapted to temperature-control the foamed mass as described here and in particular to supply heat to or remove heat from the foamed mass, as described here.

The temperature-control arrangement is adapted by means of the heat supply and/or heat removal element to prevent a surface, edge-zone or complete solidification of a foamed mass exiting from the extrusion tool within the temperature-control zone. In particular, the design of the heat supply and/or heat removal element and/or its controller provide that surface, edge-layer or complete solidification is prevented.

The heat supply and/or heat removal elements comprise one or several of the same type or different ones of the following temperature-control components. Alternatively the heat supply and/or heat removal elements correspond to one or several of the same type or different ones of the following temperature-control components. A contact temperature-control arrangement can be provided as a temperature-control component. The contact temperature-control arrangement is provided with a surface which is coupled to a heat source or heat sink of the device in a heat-transmitting manner or which comprises a heat source or heat sink. The surface extends substantially along or parallel to the longitudinal direction of the temperature control zone. The surface extends in particular substantially along or parallel to the conveying direction.

Furthermore, a temperature-control nozzle can be provided as a temperature-control component. This is adapted for dispensing temperature-control fluid in the form of a temperature-control flow. The temperature-control nozzle is directed onto the temperature-control zone. Furthermore the temperature-control nozzle can be connected to a heat source or heat sink, where the temperature-control nozzle can also be connected to a source for temperature-control fluid and/or to a pressure source. In particular, a compressed air source can be provided which comprises a heating element for the temperature-control of the compressed air. The temperature-control fluid is in particular a gas or gas mixture such as air or nitrogen or carbon dioxide or a liquid such as water or, in particular, oil. The temperature-control nozzle extends circumferentially with preferably uniform gap or a plurality of circumferentially uniformly distributed nozzles are provided. Alternatively, the nozzle is adapted for executing a rotary movement and, as a result of the rotary movement, provides a circumferentially distributed flow in the radial direction. The nozzle or nozzles can be provided together on a nozzle arrangement and can in particular be arranged on a ring. The pressing nozzle(s) can be configured in the same way as the temperature-control nozzle(s). One or more nozzle arrangements with temperature-control nozzles and/or pressing nozzles can be provided. A plurality of nozzle arrangements can follow consecutively in the conveying direction.

The temperature-control component can further comprise an electrical heating element or a combustion heating element. These are directed onto the temperature-control zone. Furthermore, the temperature-control component can comprise a heating element connected to a heat source. The heating element is equipped with an emitting surface which is directed onto the temperature-control zone. Alternatively the heating element is equipped with a contact heat transfer surface which is present in the temperature-control zone and which is in particular adapted in such a manner that the foamed mass can be guided past this surface in contact with this surface. The heating element can furthermore generally be a temperature-control element which is connected to a heat sink and/or heat source. Between the emitting surface or the contact heat transfer surface on the one hand and the heat sink and/or heat source on the other hand, there is a heat-transmitting connection which can comprise an active or passive heat medium circuit. In addition, the temperature-control component can include a microwave emitter which is directed onto the temperature-control zone. The microwave emitter is an antenna which can be connected to a microwave source.

A further embodiment provides that the device and in particular the temperature-control arrangement comprises a pressing device. The pressing device is adapted to apply a contact pressure onto the foamed mass either by contact of a solid or to apply the contact pressure onto the foamed mass by directing a fluid flow. These two possibilities can be combined and are set out in detail hereinafter.

One possibility is that the pressing device comprises at least one surface for delivering a contact pressure. This surface preferably extends substantially along or parallel to the longitudinal direction (or conveying direction) of the extrusion tool. The extrusion tool is inclined onto the surface in such a manner and in particular is disposed in such a manner relative to the surface that this applies the contact pressure onto an outer surface of a foamed mass which exits from the extrusion tool. The surface for delivering the contact pressure, and the extrusion tool and optionally further elements which guide the foamed mass, are aligned and arranged with respect to one another in such a manner that the contact pressure is obtained as described here. The surface can be provided by a contact arrangements such as a contact ring. This is preferably temperature-controlled and comprises a heating element or has a heating fluid flowing through it, which is supplied to the contact ring by a heat source or heat sink. One or a plurality of contact arrangements can be provided, where in particular a plurality of contact arrangements can follow one another in the conveying direction.

A further possibility is that the pressing device comprises at least one pressing nozzle which is directed substantially radially onto a region onto which the extrusion tool is directed in a substantially axial direction, wherein the pressing nozzle is configured for delivering a fluid flow onto this region. The pressing nozzle can be connected to a pressure source and/or to a source for fluid. The fluid which implements the fluid flow can in particular be a gas such as air, nitrogen or carbon dioxide or it can be a liquid such as water or oil.

The application of pressure makes it possible to control how strongly the foamed mass expands inside the temperature-control zone or becomes deformed in another way. In addition, the contact pressure prevents the foamed mass from bursting at the outer surface. Finally, the contact pressure serves to press the foamed mass, for example, onto a counter-bearing and/or onto a heat supply and/or heat removal element, possibly in order to prevent gaps between this element and the foamed mass.

In a further embodiment, the surface which applies the contact pressure is identical at least in sections with at least one section of a surface of a contact temperature-control arrangement or another heat supply and/or heat removal element. The surface of the contact temperature-control arrangement can correspond partially or completely to the surface for delivering the contact pressure. It can further be provided that the pressing nozzle corresponds to the temperature-control nozzle or at least the same fluid is used both for the transfer of heat and for applying the contact pressure. The temperature-control fluid is used to provide the fluid flow which produces the contact pressure.

Furthermore, the extrusion tool of the device can comprise a round-slot nozzle having a circumferentially closed slot, or a wide-slot nozzle, in particular a nozzle as is described here by reference to the method. The wide-slot nozzle can be in the form of a rectangle and have a side ratio of at least 5, 10, 15, 20, 30, 50, 75, 100, 150, 300, 600, 900, 1200 or 1500. The round-slot nozzle has a circumferentially closed slot, preferably in circular form, in the form of an oval, a rectangle or another polygon, in particular with rounded corners. The wide-slot nozzle has a profile with a straight line, with two preferably parallel straight lines, in the form of a parallelogram or in the form of a (flat) rectangle.

A further aspect relates to the possibility of varying the heat transfer and/or the application of the contact pressure with time, possibly in the course of a regulation or for adaptation to varying process parameters, possibly in a starting phase. The heat transfer or the contact pressure can be varied quantitatively here, in particular a temperature-control profile can be varied. Furthermore, the location at which the contact pressure is applied can be varied, possibly by varying the guidance, by shifting, turning or pivoting elements which guide the foamed material or which form the counter-bearing. In combination or alternatively the places at which the heat is supplied to the mass or removed from this can be varied. For example, the heat supply and/or heat removal element can be displaceable, pivotable or rotatable, preferably also detachably lockable. In particular, the surfaces which apply the contact pressure and/or the surface via which heat is transferred from/or to the foamed mass are displaceable, pivotable or rotatable, preferably also detachably lockable. The elements concerned are displaceable, pivotable or rotatable with respect to the foamed mass or the conveying direction radially, axially, circumferentially or in another direction.

In particular, the surfaces which apply the contact pressure can, in the case of hollow-profile extruder nozzles, be provided outside the entire foamed body and can be provided inside the foamed body in regions which are not filled with foamed mass. These regions correspond to hollow regions of the profile. Preferably surfaces are provided both outside and inside the foamed body which guide the foamed body and which preferably also apply the contact pressure or form a counter-bearing thereto. The surfaces or the bodies which form the surfaces are preferably pivotable, displaceable or rotatable as described above. Instead of or in combination with surfaces which apply the contact pressure, surfaces can also be provided which supply heat to the foamed body or remove heat from this. These surfaces used for temperature control are preferably also pivotable, displaceable or rotatable. The surfaces used for temperature control can be provided by bodies other than the surfaces applying the contact pressure. Preferably the surfaces used for temperature control are provided by the same bodies, elements or components as the surfaces which apply the contact pressure. In particular, the surfaces used for temperature control can be identical to the surfaces which apply the contact pressure. A mandrel can be provided within the foamed body along which the foamed body is guided. The mandrel is in particular provided to temperature-control the foamed mass and in particular to supply heat. The mandrel expands the foamed mass. The mandrel further produces the contact pressure or preferably forms the counter-bearing for this. The mandrel is provided within the temperature-control zone. The mandrel is preferably adjoined by a cylindrical body which by cooling fixes the foamable mass in its circumferential final dimensions. The cylindrical body cools the foamed mass below the solidification temperature. As a result of the cooling of the cylindrical body, the foamed mass solidifies to form a foamed body.

Subsequently further features and properties are set out which can be used to execute the method and/or to implement the device. The extrudate or the mass which is introduced into the extruder comprises a polymerisate, in particular polystyrene. The extrudate can substantially consist of the polymerisate, in particular polystyrene (apart from optionally further additives or blowing agents as described here). The extrudate comprises for example a synthetic, nature-based or renewable plastic, in particular polystyrene, polypropylene or polyethylene terephthalate. Alternatively the extrudate substantially consists of the plastic (preferably apart from optionally further additives or blowing agents as described here), in particular polystyrene, polypropylene or polyethylene terephthalate. Particularly suitable as further components of the extrudate are the mixture described in the introduction to the description or the substances described there. Likewise the steps mentioned in the introduction to the description for presenting and pre-processing the extrudate are preferably executed.

According to a further aspect, the extrudate comprises a polyolefin, in particular polypropylene or polyethylene or the extrudate substantially consists of the polyolefin, in particular polypropylene or polyethylene (preferably apart from optionally further additives or blowing agents as described here). According to a further aspect, the extrudate comprises a polycondensate, in particular polyethylene terephthalate, cellulose acetate, polylactic acid, polyhydroxy acetate or polybutylene succinate or the extrudate substantially consists of polyethylene terephthalate, cellulose acetate, polylactic acid, polyhydroxy acetate or polybutylene succinate (preferably apart from optionally further additives or blowing agents as described here). The extrudate can comprise one or more thermoplastic plastics from the group of nature-based or petroleum-based polymerisates, typically polystyrene as petroleum-based polymerisate or polycondensates.

At least one blowing agent as solid, as liquid or as blowing gas can be added to the extrudate before pouring into the extruder or during conveyance inside the extruder. The blowing agent is preferably a heat insulating gas having a lower thermal conductivity than air, e.g. a heat insulating gas for second-, third- or fourth-generation air-conditioning systems, e.g. 142b (thermal conductivity 12.9 mW/m²K) or R22 (thermal conductivity 10.5 mW/m²K) or 134a (thermal conductivity 13.7 mW/m²K) or 152a (thermal conductivity 14.3 mW/m²K) or HFO-1234ze (thermal conductivity 11.8 mW/m²K) or an alcohol, e.g. ethanol, propanol or a hydrocarbon gas e.g. butane or propane. Carbon dioxide, propane, butane, pentane, hexane, ethanol, ether, acetone, nitrogen, water or a mixture of at least two of these substances can be used as blowing agent or heat insulating gas.

In addition to the blowing agent, one or more additives can be added to the extrudate. The one or more additives comprise in particular a foam nucleating agent, dye, softeners, flame retardant, UV stabilizer, slip agent, cell stabilizer, filler or an antistatic. Here the foam nucleating agent required for foaming is possibly a passive agent consisting of talc or containing talc and/or active foam nucleating agent, in particular a chemical blowing agent which is based on an exothermic decomposition reaction such as citric acid or bicarbonate. Preferably after the fusing and mixing of the material mixture, at least one blowing agent is metered into the fused and mixed melt which withdraws heat on transition from the liquid to the gaseous state of the melt during foaming. After mixing in the blowing agent/blowing gas, the resultant mass is cooled during extrusion in the same or one or more adjoining extruders and then processed by means of the extruder nozzle, possibly a round nozzle, to form a foam body which is annular in the case of the round nozzle. In this case, the type/quantity of the blowing agent and optionally the type/quantity of the foam nucleating agent is selected so that the foam formation takes place as close as possible to the extrusion tool outlet.

After exit from the round nozzle, the foam body produced is expanded by means of inflating by internal air, in particular inside, at the end or optionally also after exit from the temperature-control zone and in particular in only partially solidified or in a completely solidified state. Furthermore, after exit from the round nozzle and preferably at the end of the temperature-control zone or after leaving the temperature-control zone, the foam body is pulled over a cooling mandrel by means of a take-off system, cut up and then wound onto winders to form rolls of foam web, preferably in the completely solidified state or also in an only partially solidified state. Optionally a subsequent expansion can take place. The foam webs obtained, resulting from the foamed mass and the foam product can be combined to achieve greater overall thicknesses as a multilayer composite in order to possibly form an insulating board.

In one embodiment, the foamed mass which is obtained by guiding the extrudate through the round nozzle is inflated to form an annular foam body having a layer thickness of >=0.1 mm by means of a flow inside the foam body. The layer thickness of the foam body is determined by the layer thickness, by the temperature-control, by the contact pressure, by the pressure of the blowing agent and optionally by the expansion due to the inflating or by the mandrel. The layer thickness is thus controlled by the aforesaid parameters and is preferably at least 0.1, 0.2, 0.3, 0.4, 0.5, 0.6, 0.7, 0.8, 0.9, 1.0 or 1.2 mm, at least 1.5 mm, at least 1.8 mm, at least 2 mm or at least 2.5 mm.

As a result of the method, a multilayer composition can be obtained if the foam product is connected in several layers. Furthermore, it complies with the standard thickness tolerance standards of insulating materials (DIN 18164). Depending on the area of application, the corresponding standard must furthermore be adhered to. For use in the roofing area, these are DIN 52612 or ASTM C 518 (thermal conductivity), DIN 53421 or ASTM D 1621 (compressive strength), ASTM D 2842 (water absorption) or/and ASTM C 355 (steam permeation). For use in the wall area these are DIN 52612 or ASTM C 518 (thermal conductivity), DIN 53421 or ASTM D 1621 (compressive strength), ASTM D 2842 (water absorption) or/and ASTM C 355 (steam barrier). For use in the floor area these are DIN 52612 or ASTM C 518 (thermal conductivity), DIN 52612 or ASTM D 1621 (compressive strength) or/and ASTM D 2842 (water absorption). The foam product according to the invention executed as a multilayer composite or resulting foam product has a thermal conductivity of <=28 mW/m²K, in particular of <=24 mW/m²K when using a heat insulating gas.

In cases of application of the thermal insulation, the use of so-called “air-conditioning system gases” (i.e. gases which are also used in air-conditioning systems) as blowing agent/blowing gas to produce the foam webs now however reduces the thermal conductivity to in some cases significantly below 30 mW/m²K and therefore to better values than the insulations established on the market (black EPS particle block foam >=32 mW/m²K, white EPS particle block foam >=40 mW/m²K, mineral wool >=36 mW/m²K). Therefore, in addition to the reduced density obtained according to the invention, a significantly increased heat insulation capacity is obtained compared with insulating products according to the prior art. If the fourth generation of “air conditioning system gases” is used (such as, for example, Honeywell HFO-1234ze), the thermal conductivity for foam products produced according to the invention can even fall below 28 mW/m²K.

Therefore, a very light and therefore cost-effective insulating product is available with this method and this device, which with very good thermal conductivities requires significantly lower thicknesses than the insulating products presently available on the market for setting a specific insulation value.

The procedure described here allows a specific temperature guidance of the extrudate and in particular at least one contact element which is used for heat transfer and alternatively or in combination with this for application of the contact pressure. It is possible that the contact pressure opposing the foaming pressure is adjustable and that in the temperature-control process and in particular at the start thereof, the cell size and the cell structure of the individual foam cells can be adjusted.

With the procedure described here it is possible that the cooling only begins when a pressure equilibrium has been established in the individual cells, whereby the maximum possible uniformity of all the cells is obtained.

As a result of the specific optimization of the foam products produced according to the invention which has been possible, a lower volumetric density is achieved with the same mechanical and/or optical product properties. The term density used herein preferably corresponds to the volumetric weight of the foamed mass or the (solidified) foam body or the (cut) foam product.

The invention further comprises a foam product produced by means of the device described here or by means of the method described here.

A method and a device are disclosed hereinafter:

A method for producing an extruded foam product, wherein an extrudate mixed with at least one blowing agent is guided through an extrusion tool, after exit from the extrusion tool the extrudate is foamed by the blowing agent to form a foamed mass, characterized in that a solidification, in particular a surface, edge-layer or complete solidification of the foamed mass exiting from the extrusion tool within a temperature-control zone adjoining the extrusion tool is prevented by temperature control of the foamed mass inside the temperature-control zone.

A device for producing an extruded foam product, wherein the device comprises an extruder with an extrusion tool, characterized in that

the device further comprises a temperature-control arrangement with a temperature-control zone, which adjoins the extrusion tool, wherein

the temperature-control arrangement has at least one heat supply and/or heat removal element, which is provided in the temperature-control zone or which is coupled to said temperature-control zone in a heat-transmitting manner, wherein

the temperature-control arrangement is adapted by means of the heat supply and/or heat removal element to prevent a complete solidification of a foamed mass exiting from the extrusion tool within the temperature-control zone.

### BRIEF DESCRIPTION OF THE DRAWINGS

The invention is explained in detail hereinafter with reference to an exemplary embodiment in conjunction with the drawings.

In the figures:

FIG. 1 shows a schematic view for more detailed explanation of the procedure described here.

FIG. 2 shows an embodiment of a temperature-control zone as is provided according to the method or according to the device described here.

### DETAILED DESCRIPTION OF THE FIGURES

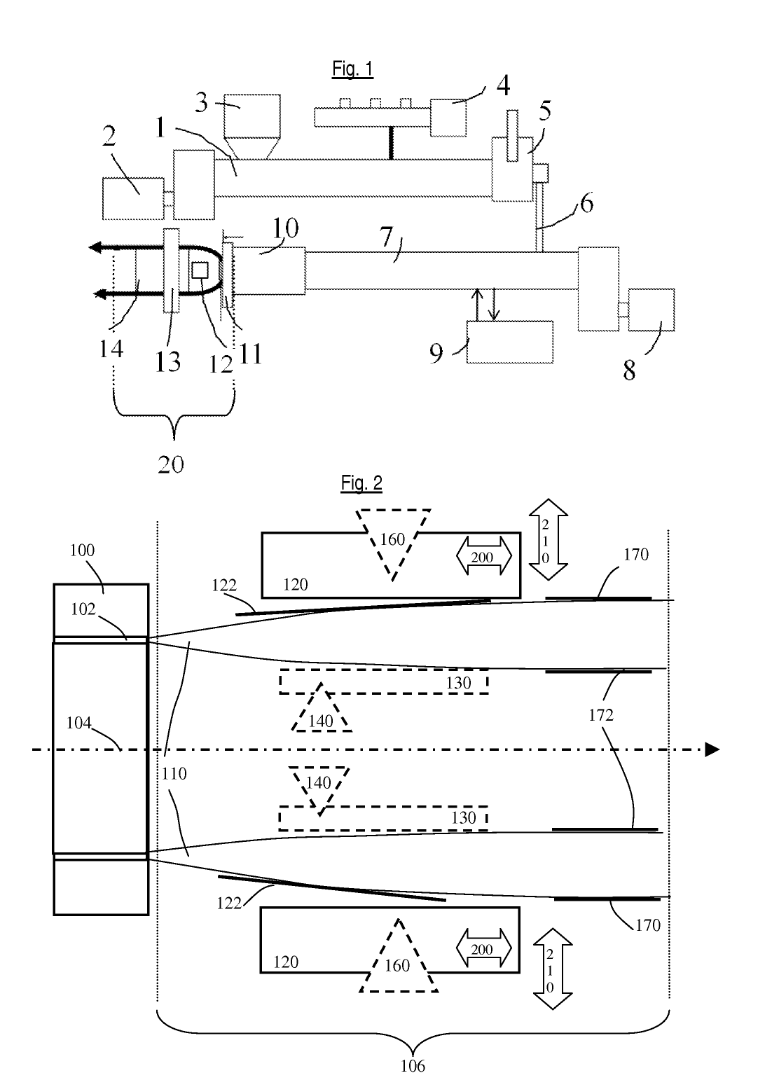

FIG. 1 shows a device for producing foam bodies, in particular a foam extrusion web system comprising two extruders. The device depicted schematically in FIG. 1 possesses a first extruder 1 with a corresponding drive 2 and a second extruder 7 with a corresponding drive 8. The starting material, i.e. the educt components of the extrudate, mixed with a foam nucleating agent and optionally one or more additives is introduced into the extruder 1 via an input hopper 3. By rotation of the extruder screw and heating, the introduced material mixture is compacted and fused. A blowing agent/blowing gas or blowing agent mixture/blowing gas mixture, for example, a mixture of carbon dioxide and ethanol, is introduced into the melt by means of one or more suitable loading devices 4. The fused mass is passed through a suitable, optional filter 5 which can optionally also adjoin the second extruder 7 and a transfer line, transfer device or a transfer extruder 6 into the second extruder 7. The first extruder 1 provides a pre-processing of the extrudate and the subsequent second extruder 7 guides the extrudate through an outlet tool 10 in order to produce a foam web and subsequently a foam body. In a further embodiment not shown, the first extruder is optional where the second extruder in this case is configured with a hopper such as the input hopper 3 and with a device such as the loading devices 4, if the first extruder is not provided. The second extruder can also comprise a filter such as the filter 5.

The material delivered from the first extruder, i.e. the extrudate, is conveyed further in the extruder 7 and thereby cooled. During the cooling phase in the second extruder 7 the fused mass is cooled by contact with the extruder with the aid of cooling water or another cooling medium which is supplied to or removed from the extruder for cooling the extruder cylinder via a cooling water container or temperature-controller 9. An appropriate cooling of the mass is important in order to achieve moderate ratios during the foaming process which takes place after leaving the extruder and to prevent the blowing agent/blowing gas from escaping too abruptly. The extrudate is delivered by means of a suitable extruder tool 10 having a round nozzle in the form of a tube having an annular or circular cross-section, where the extrudate is foamed after exit from the round nozzle as a result of the ensuing pressure release, whereby the blowing agent/blowing gas goes over from the liquid into the larger-volume gaseous state. The extruder tool 10 is adjoined in the conveying direction of the extruder by the temperature-control zone 20. Provided therein is a temperature-control nozzle 12 which delivers in particular temperature-controlled and in particular heated, air uniformly distributed circumferentially to the outside, in particular radially. The resulting temperature-control flow is directed onto the foamed mass, of which only the circumference is depicted in the form of bent, left-pointing arrows. Furthermore, an air ring or contact ring 11 is provided which provides at least one surface which applies a contact pressure from outside onto the foamed mass. The air ring or contact ring 11 can instead of or in addition to the contact pressure, supply heat to the foamed mass or remove heat therefrom. Instead of the air ring or contact ring 11, a contact arrangement or a nozzle arrangement can generally be provided. By means of this the contact pressure is applied, the foamed mass is temperature-controlled, or both.

The hollow-cylindrical foamed mass is now inflated by means of internal air or by means of an internal temperature-control flow 12 (air) and drawn over a round, temperature-controlled calibrating mandrel 14, over a calibrating ring or over calibrating rings after the outer side of the foam body has been temperature-controlled or guided possibly by an air ring or contact ring 11 or has been acted upon with a contact pressure. The contact ring provides a temperature-controlled inner surface or contact surface. Optionally a further temperature-control of the foamed mass is accomplished by means of a further optional nozzle arrangement or contact arrangement, in particular a further air ring 13. A desired temperature profile can be adjusted by means of the components 11, 12 and/or 13 if heat is removed or supplied with these. The components 11 and 13 act on the foamed mass from outside and the component 12 acts on the foamed mass from inside. None, one or a plurality of successively arranged contact or nozzle arrangements can be provided which act from outside. None, one or a plurality of successively arranged contact or nozzle arrangements can be provided which act from inside. Preferably at least one of the contact or nozzle arrangements is a heat removal or heat supply element. Furthermore, none, one or a plurality of the contact or nozzle arrangements can be a pressing device. The pressing device and the heat removal or heat supply element can be provided by a common component. Components acting from inside and from outside can be arranged successively or can be provided in an overlapping manner or on the same longitudinal section.

FIG. 2 shows as a schematic longitudinal sectional view an embodiment of a temperature-control zone which adjoins an extruder tool 100. The extruder tool 100 has a circular gap 102 through which the extrudate is guided, with the result that the foamed mass 110 is formed at the gap 102. The extrudate and the foamed mass 110 are conveyed away from the extruder tool 100, possibly through an extruder screw of an extruder (not shown) at the output end whereof an extruder tool 100 is provided. It is apparent that the hollow-cylindrical foamed mass 110 expands with increasing distance from the extruder tool 100. The dot-dash line gives the central axis 104 of the extruder tool and also gives the conveying direction by means of the end of the arrow. The extruder tool 100 is adjoined by a temperature-control zone 106 via an optional gap whose width is so small with respect to the conveying speed that the foamed mass at least does not undergo surface, edge-layer or complete solidification. In FIG. 1 the longitudinal boundaries of the temperature-control zone 106 are depicted as a dotted line. Components of a temperature-control arrangement are provided in which the temperature-control zone 106 is formed. The temperature-control arrangement comprises a heat supply or heat removal element 120 which delivers heat via thermal radiation to the foamed mass 110 or absorbs it. The element 120 can comprise an electrical heating element or has a cavity through which heat medium flows. The element 120 has a surface directed towards the foamed mass 110 which is connected by thermal radiation in a heat-transmitting manner to the foamed mass.

As an alternative or in combination with the element 120, a temperature-control nozzle 160 is provided which is aligned onto the foamed mass 110. This blows, for example, temperature-controlled and in particular heated air onto the foamed mass 110. The temperature-control nozzle 160 preferably extends circumferentially around the foamed mass. The temperature-control nozzle 160 is in particular provided by a nozzle ring. Instead of a nozzle, a plurality of nozzles arranged one after the other circumferentially can also be used.

Furthermore, a pressing device 122 is provided which has a surface for guiding and for applying a contact pressure. The surface is aligned and arranged in such a manner with respect to the extrusion tool that the foamed mass 110 exiting from the extrusion tool is passed along the pressing device 122. The surface of the pressing device 122 which is used for contact and guidance is opened in the conveying direction 104. The pressing device can in particular be provided as a contact ring. The surface of the pressing device 122 can in particular curve away from the foamed mass, preferably in the conveying direction and in the opposite direction. This also applies to further surfaces, in particular to surfaces which are used for heat transfer. The pressing device can be provided as a contact ring. The pressing device can be provided by an at least partially circumferentially running metal sheet which opens in the conveying direction. Instead of the sheet metal, a plastic plate can also be provided which is formed like the metal sheet. The metal sheet or the plastic plate can be anti-adhesion coated. The metal sheet or the plastic plate deliver heat received from the element 120 to the foamed mass 110 or deliver heat received from the foamed mass 110 to the metal sheet or to the plastic plate. The pressing device is in particular transparent with regard to the heat transfer. If the element 120 is a microwave emitter, then the pressing device is preferably transparent to microwaves.

The pressing device 122 can be provided at the same height (in the longitudinal direction) as the heat removal element 120. The pressing device 122 and the heat removal element 120 can extend over sections in the longitudinal direction which partially or completely overlap or which do not overlap and in particular lie consecutively in the longitudinal direction, for example spaced apart in the longitudinal direction via a gap section or also directly adjacent to one another. This can also apply to other components, in particular to at least two of the components 120, 122, 130, 140, 160, 170 and 172 of FIG. 2. The previously mentioned components 120, 122 and 160 are arranged circumferentially around the foamed mass. Components of the temperature-control arrangement are also provided inside the hollow foamed mass. These, like the components arranged outside, are aligned towards the foamed mass. A further heat supply or heat removal element 130 is provided inside the hollow foamed mass, which delivers heat to the foamed mass 110 or absorbs heat from this by means of thermal radiation. The element 130 has a surface directed towards the foamed mass 110 which is connected to the foamed mass by thermal radiation in a heat-transmitting manner. It can be seen that the element 130, like the element 120, also has a section at which the relevant element is in contact with the foamed mass 110. In this section, the surface of the contact temperature-control arrangement corresponds to the surface of a pressing device.

A further temperature-control nozzle 140 which is directed outwards to the foamed mass is provided as a further optional element. The blows, for example, temperature-controlled and in particular heated air onto the foamed mass 110. The temperature-control nozzle 140 preferably extends completely circumferentially around the central axis 104 and is located inside the foamed mass 110. The temperature-control nozzle 140 is in particular provided by a nozzle ring. Instead of a nozzle, a plurality of nozzles arranged circumferentially adjacent to one another can also be used. Instead of the temperature-control nozzle 140 and/or 160, a pressing nozzle can be provided. This is configured like the temperature-control nozzle where the fluid delivered by the nozzle need not have any specific temperature properties. However, a minimum flow rate can be provided at the nozzle outlet (or a minimum volume throughput) in order to specifically provided the contact pressure. The functions of the temperature-control nozzle and the pressing nozzle can be combined. In this case, this nozzle is operated in such a manner that the contact pressure is adjusted (for example, by means of the minimum flow rate or by means of the minimum volume throughput) and that the temperature-control is obtained (possibly by heating or cooling the fluid delivered by the nozzle).

Further elements 170, 172 which lie downstream of the elements 120-160 can be provided. The elements 170, 172 form surfaces arranged inside and outside the foamed mass which are each in contact with the foamed mass 110. These elements 170 form surfaces which guide the foamed mass 110. Depending on the degree of solidification, the surfaces of the elements 170, 172 can apply a contact pressure so that cells inside the foamed mass still remain plastically deformable and cell sizes can be homogenized. If the outer surface of the foamed mass 110 is possibly not yet solidified in such a manner that the pressure of the blowing agent can deform the outer surface at this point, the surfaces of the elements 10, 172 then apply a contact pressure. In this case, the element 170 or the element 172 can serve as counter-bearings. Furthermore, the elements 170, 172 can also be a contact temperature-control arrangement, for example, an arrangement through which temperature-controlled heat medium flows. If the elements 170, 172 not only guide but also apply a contact pressure, the elements 172, 170 combine a contact temperature-control arrangement and a pressing device with a surface for delivering a contact pressure. In this case, the surface of the contact temperature-control arrangement partially or completely corresponds to the surface of the pressing element for delivering the contact pressure. After exit from the elements 170, 172, the foamed mass 110 is preferably completely solidified. If not, a further, following temperature-control arrangement can be provided for removal of heat, for example, a cooling arrangement in the form of a contact ring or cooling ring.

According to an advantageous specific embodiment to explain the invention, which is set out in this paragraph, the elements 170, 172 are surfaces of a pressing device which apply the contact pressure to the foamed mass. The element 120 is a surface of a temperature-control arrangement which provides heat transfer by thermal radiation. The optional nozzle 140 delivers a fluid flow for applying a contact pressure and the optional nozzle 160 delivers a temperature-control flow. If the optional nozzle 160 is provided, the element 122 can be omitted. If the element 122 is provided, this is then a contact temperature-control arrangement. This can, for example, be mounted radially movably so that this only guides but does not apply any contact pressure. Alternatively, the element 122 can be a combined contact temperature-control device and pressing device which provides one surface as a heat removal or heat supply element which is at least partially a surface for applying the contact pressure. The optional nozzle 160 and/or the optional nozzle 140 can however also deliver a flow as a combined fluid flow and temperature-control flow and therefore be used for temperature control and for applying the contact pressure. In particular, the temperature-control arrangement is formed by one or by several of the aforesaid components 120, 122, 130, 140, 170 or 172. Each of the aforesaid components 120, 122, 130, 140, 170 or 172 can be provided singly or multiply. In the last-mentioned case a plurality of components of the same type are arranged along the conveying direction 110 and/or provided inside and/or outside the foamed mass. The components 120, 122, 130, 140, 170 or 172 are depicted merely schematically where the drawing elements used for the diagram in particular are not intended to represent the shape of the components realized. The drawing elements give the arrangement of the components with respect to the extruder tool 100, with respect to the foamed mass 110, with respect to the conveying direction 104 (=axial direction) or the arrangement of the components amongst one another, in particular in the radial or axial direction. The double arrows 200 and 210 depict as an example the possible directions of displacement of the component 120 or the components 160. All, a plurality of or only one component of the components 120, 122, 130, 140, 170 or 172 can be displaceable according to the double arrows 200 and/or 210. Double arrow 210 corresponds to a displacement in the radial direction. Double arrow 210 corresponds to a displacement in the axial direction. The lines used to represent the foamed mass further give the outer surface of the foamed mass in cross-sectional view.

1. A method for producing an extruded foam product, wherein an extrudate mixed with at least one blowing agent is guided through an extrusion tool (100), after exit from the extrusion tool the extrudate is foamed by the blowing agent to form a foamed mass (110),
characterized in that a solidification, in particular a surface, edge-layer or complete solidification of the foamed mass (110) exiting from the extrusion tool within a temperature-control zone (106) adjoining the extrusion tool is prevented by temperature control of the foamed mass (110) inside the temperature-control zone, wherein inside the temperature-control zone (106) an adjustable contact pressure on an outer surface of the foamed mass (110) is applied by means of a pivotable, displaceable or rotatable surface or by means of a fluid flow directed onto the surface of the foamed mass.

2. The method according to claim 1, wherein a duration and/or a temperature profile of the temperature control provide a pressure compensation between closed cells of different cross-sectional position in the foamed mass (110) by plastic variation of the cells.

3. The method according to claim 1, wherein a duration and/or a temperature profile of the temperature control and/or a pressure provided by the blowing agent prevents bursting of cells at an outer surface of the foamed mass (110).

4. The method according to claim 1, wherein during the temperature control of the foamed mass (110) heat is supplied or removed from this, in particular by physical contact between the foamed mass (110) and a surface (122) along which the foamed mass (110) is passed, by guiding a temperature-control flow along the mass and/or by irradiating with thermal radiation or microwave radiation.

5. The method according to claim 1, wherein within the temperature-control zone (106) the contact pressure is applied to the outer surface of the foamed mass (110) by guiding the foamed mass along the surface (170) which applies the contact pressure to the outer surface and/or by directing a fluid flow onto the outer surface of the foamed mass (110), wherein in particular the contact pressure applied by the outer surface and/or the fluid flow is at least as high as a resulting foaming pressure which is produced by the blowing agent inside the foamed mass in order to locally delimit the cross-section of the foamed mass or the contact pressure is lower than the foaming pressure in order to increase the cross-section of the foamed mass (110).

6. The method according to claim 1, wherein the surface and/or the fluid flow which applies the contact pressure to the outer surface of the foamed mass (110), supplies heat to the foamed mass or removes heat from it by physical contact and/or by thermal radiation.

7. The method according to claim 1, wherein the extrusion tool (100) through which the extrudate is guided, comprises a round-slot nozzle having a circumferentially closed slot (102), a profile nozzle or a wide-slot nozzle through which the extrudate is guided in order to form the foamed mass (110) as an annular or flat or profiled foam body.

8. Device for producing an extruded foam product, wherein the device comprises an extruder (7, 8) with an extrusion tool (10, 100),
characterized in that
the device further comprises a temperature-control arrangement (120-170) with a temperature-control zone (106), which adjoins the extrusion tool, wherein the temperature-control arrangement (120-170) has at least one heat supply and/or heat removal element (120, 122), which is provided in the temperature-control zone (106) or which is coupled to said temperature-control zone in a heat-transmitting manner, wherein
the temperature-control arrangement is adapted by means of the heat supply and/or heat removal element to prevent a complete solidification of a foamed mass (110) exiting from the extrusion tool within the temperature-control zone (106) and the device has a pressing device (170, 172) which is configured to apply an adjustable contact pressure onto an outer surface of the foamed mass.

9. The device according to claim 8, wherein the heat supply and/or heat removal elements comprise one or a combination of several same-type or different ones of the following temperature-control components:
(a) a contact temperature-control arrangement (122) with a surface which is coupled to a heat source or heat sink of the device in a heat-transmitting manner and the surface extends substantially along or parallel to the longitudinal direction (104) of the temperature control zone (106);
(b) a temperature-control nozzle (160) adapted for dispensing temperature-control fluid in the form of a temperature-control flow, wherein the temperature-control nozzle is directed onto the temperature-control zone and the temperature-control nozzle is connected to a heat source or heat sink;
(c) an electrical heating element (120), a combustion heating element or heating element connected to a heat source which is equipped with an emitting surface which is directed onto the temperature-control zone; or
(d) a microwave emitter which is directed onto the temperature-control zone and in particular the foamed mass (110).

10. The device according to claim 8, wherein the pressing device (170, 172) is in particular comprised by the temperature-control arrangement and the pressing device (170, 172)
(i) comprises at least one surface for delivering a contact pressure, which extends substantially along or parallel to the longitudinal direction (104) of the extrusion tool (100), wherein the extrusion tool is directed in an inclined manner onto the surface or is aligned along the surface and is disposed in such a manner relative to the surface that this applies the contact pressure onto an outer surface of a foamed mass which exits from the extrusion tool and/or
(ii) which has at least one pressing nozzle (140) which is directed substantially radially onto a region onto which the extrusion tool is directed in a substantially axial direction, wherein the pressing nozzle is configured for delivering a fluid flow onto this region.

11. The device according to claim 10, wherein the surface of the contact temperature-control arrangement corresponds partially or completely to the surface for delivering the contact pressure and/or wherein the pressing nozzle corresponds to the temperature-control nozzle.

12. The device according to claim 8, wherein the extrusion tool comprise a round-slot nozzle having a circumferentially closed slot, a profile nozzle or a wide-slot nozzle.
